(19) United States
(12) Patent Application Publication
(10) Pub. No.: US 2002/0194303 A1
(43) Pub. Date: Dec. 19, 2002

(54) Portable shopping assistant

(75) Inventors: Mika Suila, Helsinki (FI); Ari Ikonen, Raisio (FI); Kimmo Hamynen, Espoo (FI); Caj Eklund, Helsinki (FI); Kirsi Malk, Espoo (FI); Elina Aho, Helsinki (FI)

Correspondence Address: COHEN, PONTANI, LIEBERMAN & PAVANE, 551 Fifth Avenue, Suite 1210, New York, NY, 10176, US

(73) Assignee: Nokia Corporation

(21) Appl. No.: 09/867,288

(22) Filed: May 29, 2001

(51) Int. Cl. G06F 15/16

(52) U.S. Cl. 709/218; 709/219; 709/249

(57) ABSTRACT

A system and method of providing consumer item information to consumers by equipping the consumers with portable shopping assistants (PSAs), which can receive identifying information (OI-Id) concerning specific consumer items (OIs). The PSA transmits the OI-Id to an information server system (ISS), which responds with either the appropriate consumer item information (P/S-Info) or a “key” (OI-Key) which can be used to retrieve the P/S-Info.

### BACKGROUND OF THE INVENTION

1. Field of the Invention

This invention relates generally to a system and method for using consumer item information received from consumer item information providers to access and/or receive product or service information concerning the consumer item. More particularly, the system and method relates to the receiving of consumer item identification information and transmitting it to a product or service information source, which sends the appropriate product or service information to a predetermined output means.

2. Description of the Related Art

Recent advances in technology, such as the advent of the Internet and cellular telephone systems, have enabled individuals to access more information more quickly than ever before. An individual with a personal computer (PC) and an Internet connection may obtain up-to-date information concerning products and services by directly accessing a manufacturer's, service provider's, or consumer advocate's websites. However, this type of “web-surfing” is done at home and is of little assistance to those who are shopping and browsing in the real world. Presently, it is possible to access the Internet from a mobile terminal, such as a cellular telephone, by using the Wireless Application Protocol (WAP). But web-surfing using WAP on current cellular telephones is very limited, both because the display screen on a cellular telephone is small and best suited to text or simple icon images and because current WAP-enabled telephones can access only a limited number of websites, often arranged by the cellular telephone network operator.

The problem of performing real-world shopping with the assistance of the information resources and capabilities of the Internet have been approached in U.S. Pat. No. 6,134,548 to Gottsmann et al., entitled SYSTEM, METHOD AND ARTICLE OF MANUFACTURE FOR ADVANCED MOBILE BARGAIN SHOPPING (hereinafter referred to as “MOBILE BARGAIN SHOPPING”). MOBILE BARGAIN SHOPPING discloses a system in which a cellular phone, equipped with a miniature barcode reader, scans in the Uniform Product Code (UPC) barcode label on a retail product in a real world retail environment, such as a bookstore. The cellular telephone is also equipped with an Internet Protocol (IP) capability, such as that provided by WAP, and it uses that capability to transmit the scanned-in barcode to a web server. The web server converts the scanned-in barcode into an appropriate identifier (e.g., the International Standard Book Number-ISBN, in the case of a book) and then contacts appropriate third-party web sites to find price, shipping, and availability information on the labeled product from various web suppliers. This information is formatted and displayed on the cellular telephone's screen. Furthermore, a user may order a particular product using the web server interface from the cellular telephone.

However, the MOBILE BARGAIN SHOPPING system only works in making on-the-spot compulsive decisions regarding purchases. The pricing, shipping, and availability information are shown in real-time, so that the user may perform comparison shopping concerning a consumer item currently in the user's presence. The system is of no assistance for a user who wishes to obtain more information about the product itself, or for a user who wishes to make a more reasoned and educated decision regarding the purchase, rather than a quick determination of the lowest price.

In short, the MOBLE BARGAIN SHOPPING system is only useful for real-time on-the-spot price comparisons of consumer items. It is not useful for the user who wishes to obtain more in-depth information regarding a particular consumer item. Furthermore, it is not useful for the user who wishes to examine and understand the more in-depth information on a larger more suitable display screen, such as a home PC's display screen. Further still, the MOBILE BARGAIN SHOPPING system is not useful for the user to receive promotional material, such as electronic coupons and the like, concerning a particular consumer item, where the user may use the promotional material later.

Accordingly, there is a need for a system and method by which a user may obtain more information regarding a consumer item which the user may consider and digest in the comfort of the user's home. Further, there is a need for a system and method for providing other types of material, such as electronic coupons or promotional material, which the user may use at his home.

### SUMMARY OF THE INVENTION

In accordance with one aspect of the present invention, there is provided a system which provides consumer item information to a user. The consumer item in which the user is interested is hereinafter referred to as the object of interest (OI). The system comprises an OI identification information (OI-Id) provider, which is positioned in a location where the OI is present, a location having material associated with the OI, or a location where an event associated with the OI is taking place. The user is equipped with a portable shopping assistant (PSA) which receives the OI-Id from the OI-Id provider and transmits the received OI-Id to an information server system (ISS). The ISS receives the transmitted OI-Id and matches it with a record containing the product or service information (P/S-Info) corresponding to the received OI-Id. The ISS determines a communication method, and then transmits the P/S-Info to an output device using the determined communication method.

In accordance with another aspect of the present invention, there is provided a system which provides information concerning a consumer item to a user. This system also has an ISS, a PSA, and an OI-Id provider, which is positioned in a location where the OI is present, a location having material associated with the OI, or a location where an event associated with the OI is taking place. However, when the PSA transmits the OI-Id to the ISS, the ISS responds by matching the received OI-Id with a record containing an key information (OI-Key) corresponding to the received OI-Id. The OI-Key is used to access the P/S-Info concerning the OI. The ISS transmits the OI-Key directly back to the PSA. The user utilizes an input/output (I/O) device which receives the OI-Key previously received by said PSA and then transmits the received OI-Key to a P/S-Info server. The P/S-Info server matches the OI-Key with a record containing the P/S-Info, and then allows the I/O device to access the P/S-Info.

In accordance with another aspect of the present invention, there is provided a method which provides consumer item information to a user. In the method, an identifier (OI-Id) concerning an object of interest (OI) is received by a portable shopping assistant (PSA) in a specific location. The specific location can be a location where the OI is present, a location having material associated with the OI, or a location where an event associated with the OI is taking place. The OI-Id is transmitted by the PSA to an information server system (ISS), which matches it with a record containing product or service information (P/S-Info) about the OI. The ISS determines which communication method to use to transmit the P/S-Info; and then transmits the P/S-Info in the matching record to an output device using the determined communication method,. The output device outputs the P/S-Info to the user.

In accordance with still another aspect of the present invention, there is provide a method which provides consumer item information to a user. In the method, a portable shopping assistant (PSA) receives an identifier (OI-Id) having identification information concerning an object of interest (OI). This receiving occurs in a specific location, such as a location where the OI is present, a location having material associated with the OI, or a location where an event associated with the OI is taking place. The PSA transmits the OI-Id to an information server system (ISS), which matches it with a record containing key information (OI-Key), which can be used to access consumer item information (P/S-Info) concerning the OI. The ISS transmits the OI-Key of the matching record to the PSA. The OI-Key is input from the PSA to an input/output (I/O) device, which transmits it to a P/S-Info server having a record containing the P/S-Info concerning the OI. After the P/S-Info server matches the OI-Key with the record containing the P/S-Info, it allows the I/O device to access the P/S-Info.

In accordance with yet another aspect of the present invention, there is provided a portable shopping assistant which provides consumer item information to a user. The portable shopping assistant comprises a receiver unit, at least one memory unit, a processor, and a communication unit. The receiver unit receives, in a specific location, an identifier (OI-Id) having identification information concerning an object of interest (OI). The at least one memory unit stores processor-readable code and selectable output device information, which comprise communication destination addresses of each of a plurality of output devices. The processor is operatively coupled to the at least one memory and is configured to implement the processor-readable code. The processor-readable code is configured to maintain the selectable output device information, allow the user to select the selectable output device information comprising a communication destination address of a user desired output device, and attach the user-selected selectable user information to the received OI-Id. The communication unit communicates via a network in order to transmit the OI-Id with the attached user-selected output device information to an information server system (ISS). The ISS, after receiving the OI-Id transmitted by said portable shopping assistant via the network, matches the received OI-Id with a record containing corresponding consumer item information (P/S-Info), determines a communication path to be used in transmitting the P/S-Info, and transmits the P/S-Info contained in the matching record to the user desired output device using the user-selected output device information attached to the OI-Id.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference numerals delineate similar elements throughout the several views:

FIG. 1A is an abstract representation of the functional modules in a consumer information system according to one presently preferred embodiment of the present invention;

FIG. 1B is another abstract representation of the functional modules in a consumer information system according to another presently preferred embodiment of the present invention;

FIGS. 2A, 2B, and 2C are exemplary implementations of the PSA 120 and the OI-Id Provider 110 from FIGS. 1A and 1B;

FIGS. 3A, 3B, and 3C are exemplary implementations of PSA 120, ISS 130, P/S-Info Server 131, and Output 140 or I/O 150 from FIGS. 1A and 1B;

FIG. 4 is an exemplary embodiment of a FIG. 1A system according to the present invention;

FIG. 5 is an exemplary embodiment of a FIG. 1B system according to the present invention;

FIG. 6 is another exemplary embodiment of a FIG. 1A system according to the present invention; and

FIG. 7 is an exemplary implementation of an ISS Server for multimode P/S-Info broadcast communication according to the present invention

### DETAILED DESCRIPTION OF THE PRESENTLY PREFERRED EMBODIMENTS

To overcome limitations in the prior art described above, and to overcome other limitations that will be apparent upon reading and understanding the present specification, the present invention discloses a system, apparatus, and method for a portable device to receive an identifier from and/or about a consumer object and to transmit the consumer object identifier to a storage for consumer object information, and for an output means to receive consumer object information from the storage, whereby a user may access the received consumer object information.

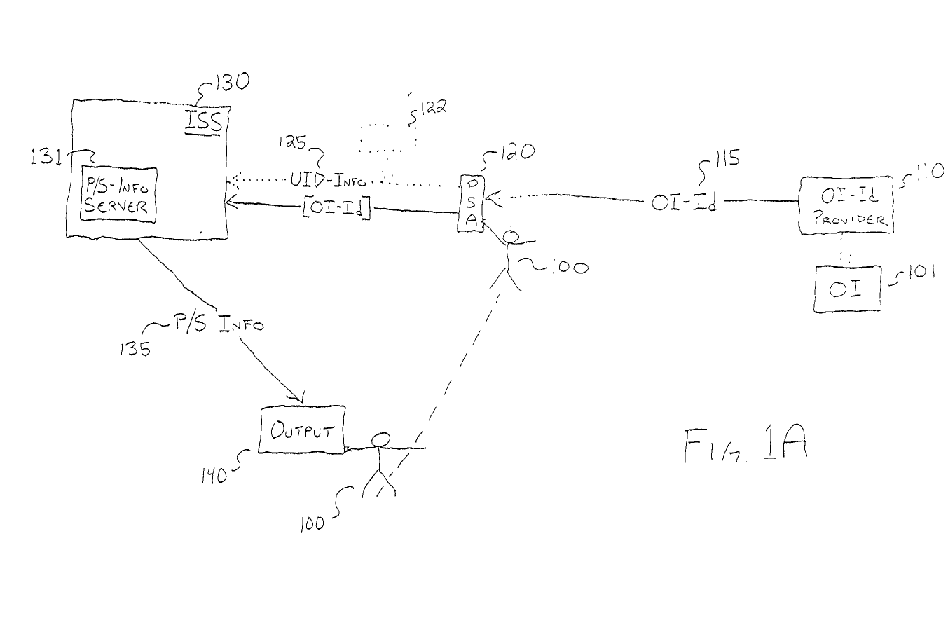

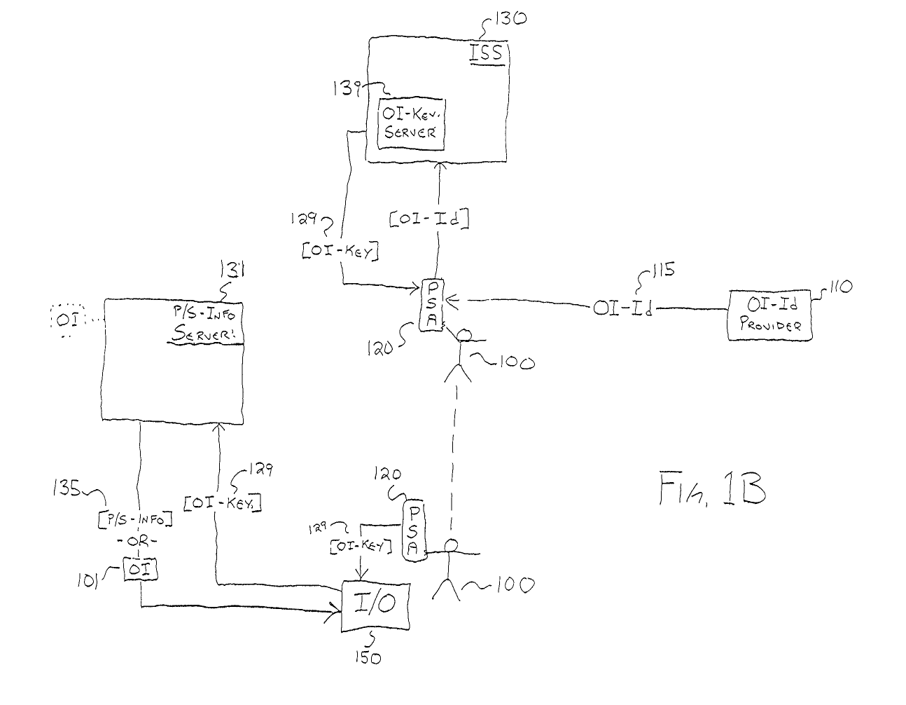

In general, the system and method is comprised of the abstract functional modules shown in FIGS. 1A and 1B. Each functional module may be implemented as one or more electronic, mechanical, or other type of means for performing one or more electrical, mechanical, or computing/processing task. In order to exemplify the wide range of implementations possible for the modules in FIGS. 1A and 1B, some, but not all, realizations of the various modules are shown in the figures following FIGS. 1A and 1B.

In FIG. 1A, a consumer item, or Object of Interest (OI), 101 has an Object of Interest Identifier (OI-Id) Provider 110 which may be attached or connected to itself. The OI 101 can be a product or a service—essentially, anything that can be bought, sold, or rented. The OI-Id Provider 110 provides OI-Id 115 to a Portable Shopping Assistant (PSA) 120 of a user 100. The OI-Id 115 comprises identification data about OI 101. In addition, OI-Id 115 may comprise a solicitation identification concerning the OI or a related product/service, OI information, or an entry form. As shown by the dotted line, in other configurations, the OI-Id Provider 110 is not necessarily connected or attached to OI 101. Such an unconnected configuration is applicable to instances where the OI 101 is a service, such as gardening, rather than a product, or to instances where the OI 101 is an item ill-suited for connecting or attaching OI-Id Provider 110, such as food at a restaurant. In addition, the unattached configuration is applicable to situations where the OI-Id Provider 110 is part of an advertisement, a display, an event, or a promotional campaign—any of which may be separated in time and distance from OI 101.

PSA 120 receives the OI-Id 115 and transmits it to Information Server System (ISS) 130. In addition, user identification information (UID-Info) 125 concerning user 100 may also be transmitted to ISS 130. UID-Info could also comprise index numbers indicating marketing profile or a communication address for receiving P/S-Info (described below). As shown by the dotted line and the dotted box in FIG. 1A, this UID-Info 125 may be added to the transmission of OI-Id 115 by PSA 120 or may be added to the transmission of OI-Id 115 by another module 122. In another embodiment, a user identifier (UID) may be attached by the PSA 120 or by another module, and the ISS uses that UID to look up UID-Info 125 concerning user 100.

ISS 130 comprises Product/Service Information (P/S-Info) Server 131, in which product or service information (i.e., P/S-Info) regarding OI 101 is stored. P/S-Info may be, for example, product and/or service information, an e-coupon, or an e-mail with a webpage address. An e-coupon (or electronic coupon) is a coupon in electronic format, such as an e-mail or other type of electronic transmission, which may be printed out or uploaded in order to be redeemed. P/S-Info Server 135 uses the OI-Id 115, which identifies OI 101, in order to find the appropriate P/S-Info regarding OI 101. Once found, this information is sent by ISS 130 as P/S-Info 139 to Output 140.

In some embodiments, UID-Info 135 may comprise location information concerning Output 140. In those embodiments, ISS 130 determines the appropriate Output 140 to which to transmit the P/S-Info 135 by parsing information contained in UID-Info 125. At Output 140, which may be located at user 100's home or at a shop that user 100 is currently visiting, user 100 accesses the P/S-Info 135 regarding OI 101. Output 140 may be a personal computer (PC) or television set at the home of user 100, or a laptop computer or a pair of virtual reality goggles which user 100 is carrying with him. In another embodiment, the user may choose which output device to send the P/S-Info. In such an embodiment, the user would select, using the PSA, from among different communication destination addresses (such as a portable laptop computer or the home TV set) the final destination output device for the P/S-Info. The PSA in this embodiment would attach the user-selected communication destination address to the OI-Id before transmitting both to the ISS.

The various means of communication between OI-Id Provider 110 and PSA 120, between PSA 120 and ISS 130, and between ISS 130 and Output 140 may be comprised of one or more networks or individual communication links, each of which may be wired or wireless. For instance, the communication means between PSA 120 and ISS 130 may comprise several “hops” from a wireless cellular network to a point-to-point wired connection, and then from the point-to-point wired connection to a wired Wide Area Network (WAN). In some cases, the communication link may be comprised of human interaction. For example, OI-Id 115 may be transferred to PSA 120 by user 100 reading OI-Id from OI-Id Provider 110 and then manually entering OI-Id 115 into PSA 120.

FIG. 1B shows additional functional modules besides the functional modules shown in FIG. 1A, with a slightly different configuration. Similarly to the FIG. 1A configuration, OI-Id 115 is downloaded from OI-Id Provider 110, and then PSA 120 transmits it to ISS 130. In contrast to the FIG. 1A configuration, ISS 130 contains OI-Key Server 139, which has a matching OI-Key for each OI-Id. The matching OI-Key 129 is found in OI-Key Server 139 and transmitted to PSA 120. Later on, user 100 downloads OI-Key 129 into Input/Output (I/O) 150. User 100 may do this manually, or the PSA 120 and I/O 150 may have a communication link for downloading this information. Using the downloaded OI-Key 129, I/O 150 contacts or logs in to P/S-Info Server 131. User 100 would then use this communication connection with P/S-Info Server 131 either to obtain P/S-Info 135 or to purchase OI 101. Although ISS 130 and P/S-Info Server 131 are depicted separated in FIG. 1B, they may very well be on the same network, or both connected to the Internet.

One way of looking at these figures is that FIG. 1A follows a “push” model, and that FIG. 1B follows a “pull” model. ISS 130 sends, or pushes, P/S-Info 135 to Output 140 in FIG. 1A, so that user 100 will find it there. By contrast, user 100 sends OI-Key 129 to P/S-Info Server 131 in order to receive, or pull in, OI 101 or P/S-Info 135.

It should be noted that there are variations and adaptations that may be made to the abstract representations in both FIGS. 1A and 1B. For instance, the UID-Info 125 shown in FIG. 1A may be added to OI-Key 129 by either PSA 120 or ISS 130 in FIG. 1B. Output 140 in FIG. 1A could be an I/O 150 as shown in FIG. 1B. OI 101 could be connected to OI-Id Provider 110 in FIG. 1B as it is in FIG. 1A.

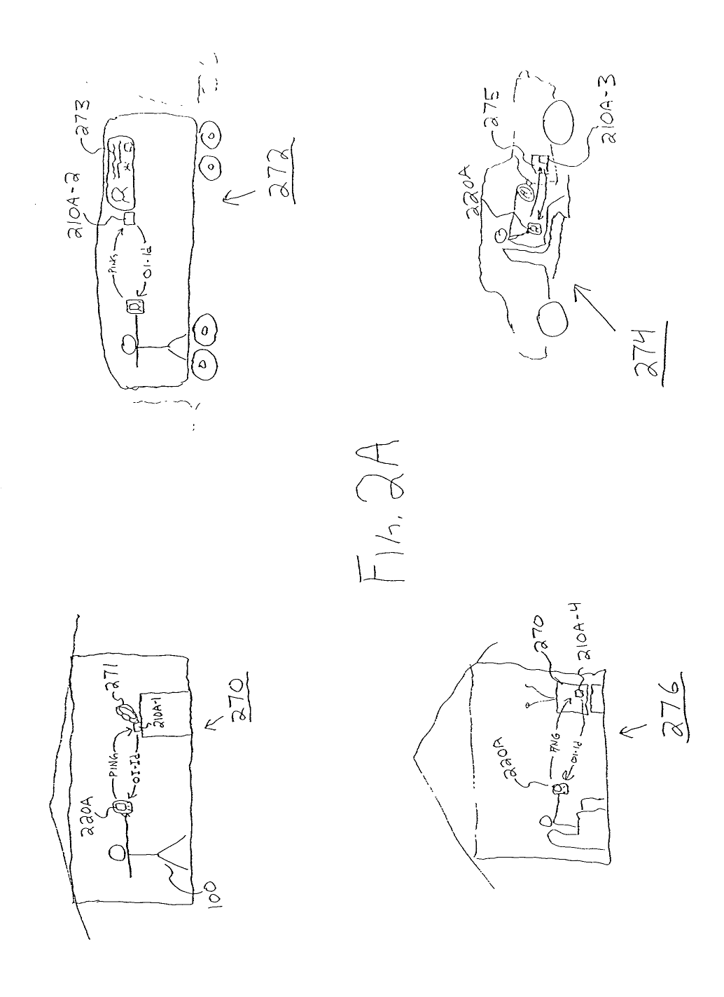

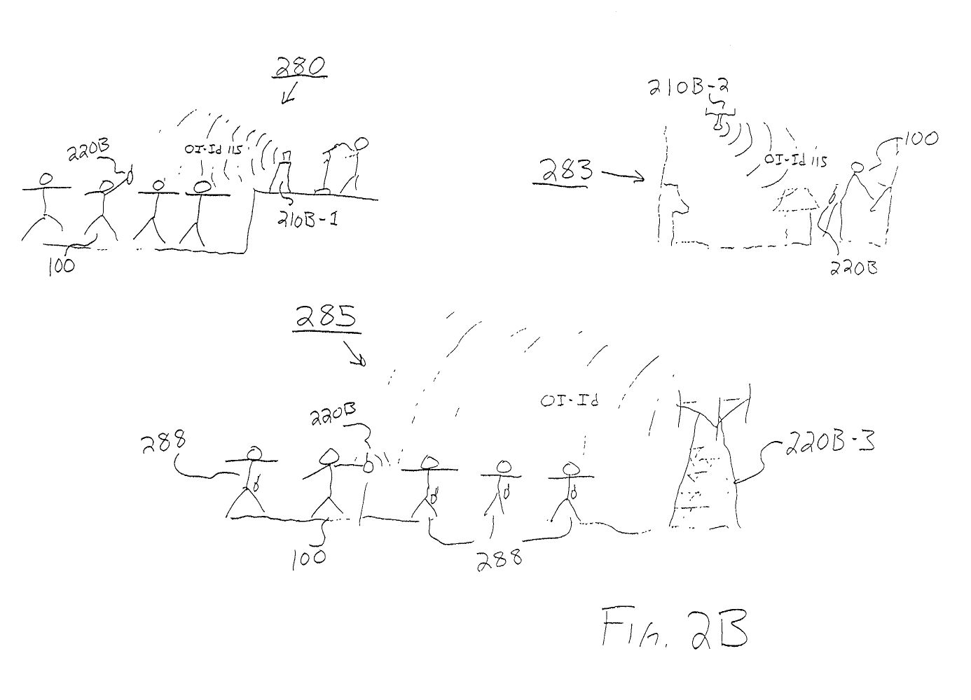

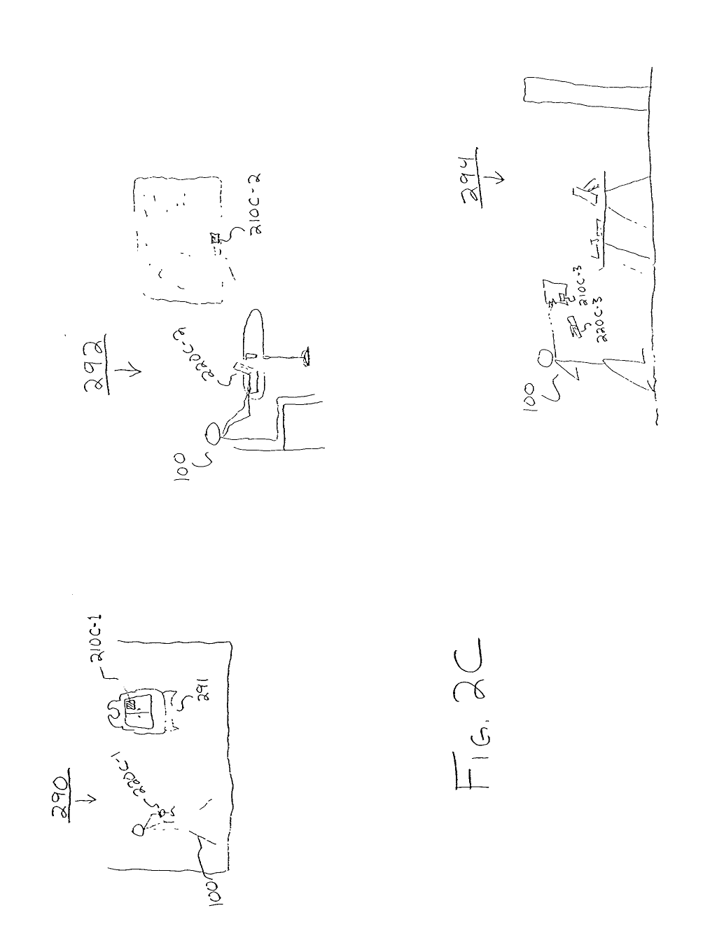

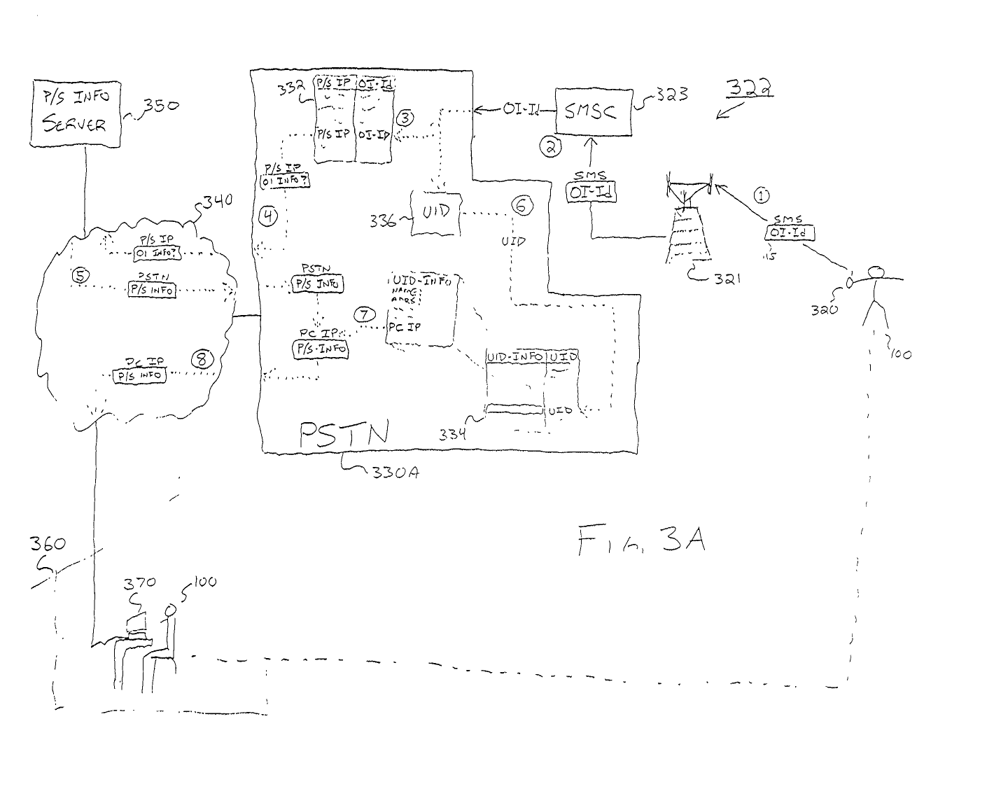

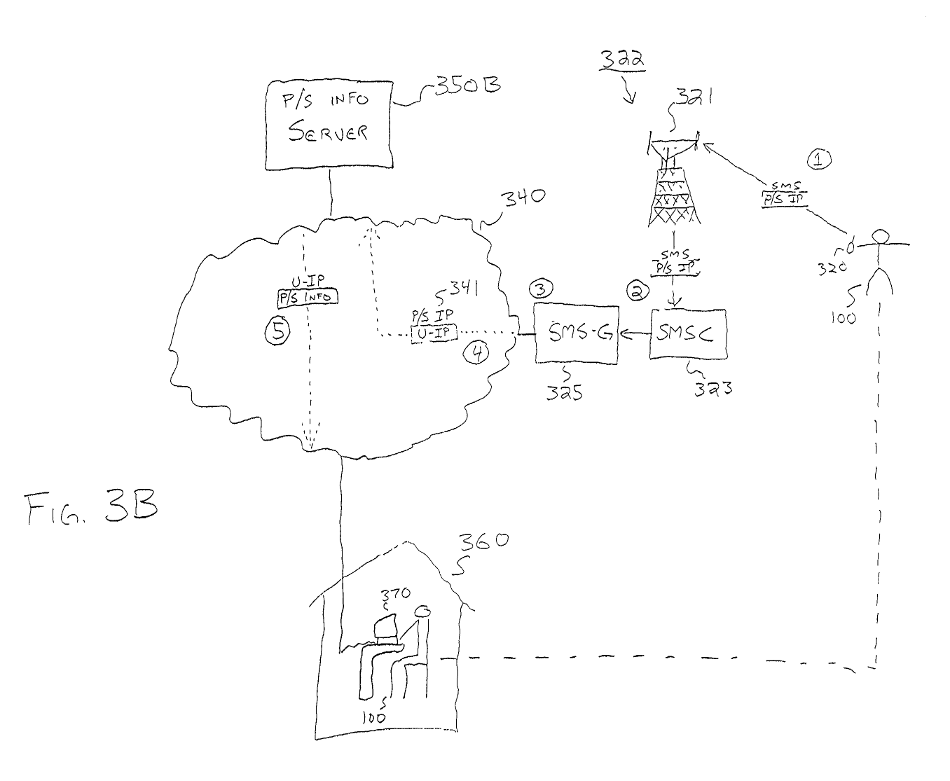

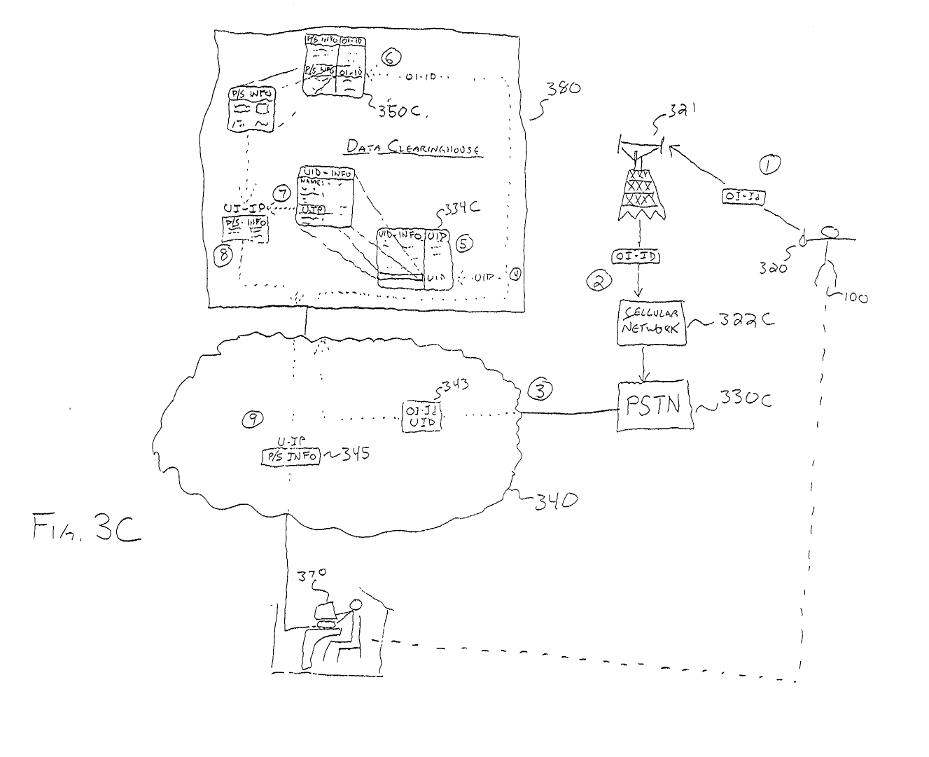

The range of devices, systems, and methods which may be used to implement the configurations of FIGS. 1A and 1B will be shown by the exemplary implementations of various functional modules in FIGS. 2A through 3C. Specifically, exemplary implementations of PSA 120 and OI-Id Provider 110 are shown in FIGS. 2A, 2B, and 2C; exemplary implementations of PSA 120, ISS 130, P/S-Info Server 131, and Output 140 or I/O 150 are shown in FIGS. 3A, 3B, and 3C. In order to fully emphasize the broad range of implementations, the functional modules exemplified in each figure will be considered in isolation from the rest of the system. In other words, when an implementation of an OI-Id Provider 110 is shown in FIG. 2B, for example, the manner in which P/S-Info Server 131 or I/O 150 are implemented is not considered or shown. This reinforces the vast number of combinations possible by mixing and matching the particular technologies when implementing a system according to the present invention.

As mentioned above, various implementations of PSA 120 and OI-Id Provider 110 are shown in FIGS. 2A-2C. More specifically, FIG. 2A shows a prompted radio-frequency (RF) implementation; FIG. 2B shows an unprompted RF implementation; and FIG. 2C shows a non-RF implementation.

In FIG. 2A, user 100 holds a Personal Digital Assistant (PDA) 220 implementation of PSA 120 which is used to download OI-Id 115 from various forms of OI-Id Providers 210A. Both PDA 220 and OI-Id Providers 210A use radiofrequency (RF) technology for the transmission of OI-Id 115. PDA 220 contains an active transceiver and OI-Id Providers 210A comprise passive electronic circuits. These passive electronic circuits are activated by a signal 213 transmitted from PDA 220 and, in response to RF signal 213, transmit OI-Id 115 to PDA 220. Such technology is used presently in the Mobil Speedpass system, where credit card information is transmitted by passive circuits embedded in a keychain, when that keychain is waved in the vicinity of a RF source. In this example, user 100 prompts or “pings” (sends signal 213 to) OI-Id Providers 210A by pressing one or more buttons on PDA 220 when user 100 desires that OI-Id 115 be transmitted to PDA 220. In other embodiments, PDA 220 may continually broadcast a low-power RF signal which automatically activates all OI-Id Providers 210A within a certain distance. In those embodiments, the PDA 220 would inform user 100 of the receipt of OI-Id 115 and user 100 either stores and/or acts upon the received OI-Id 115 or ignores and/or erases the received OI-Id 115.

FIG. 2A depicts four different exemplary scenarios where user 100 may ping OI-Id Providers 210A. In the first scenario, user 100 pings OI-Id Provider 210A-1 which is attached to watch 271 in retail store 270. In this case, user 100 is interested in buying the watch but wants to receive more information concerning the watch which user 100 may examine at his leisure. Thus, after pinging OI-Id Provider 210A-1, user 100 stores the received OI-Id 115 in PDA 220A for later retrieval and usage.

In the second scenario, user 100 spots an advertisement 273 concerning a product or service he is interested in a train compartment 272. User 100 pings OI-Id Provider 210A-2 which is attached to advertisement 273, thus receiving OI-Id 115 concerning the product or service of interest.

In the third scenario, user 100 is driving in automobile 274 when he hears a song that interests him on radio 275. User 100 pings radio 275 to receive OI-Id 115 concerning the currently playing song. In this case, the radio system is set up so that the radio station broadcasts an OI-Id signal simultaneously with each song, and radio 275 has an OI-Id Provider 220A-3 comprising a small internal memory which stores the OI-Id for the duration of the current song and a low-power RF transceiver. If pinged, OI-Id Provider 210A-3 transmits the presently stored OI-Id to PDA 220A. In another embodiment, radio 275 and PDA 220A would have integrated functionality so that user 100, by pressing a single button on radio 275, would have OI-Id 115 automatically downloaded to PDA 220A.

In the fourth scenario, user 100 is home 276 at night watching television (TV) 277 when a commercial is broadcast indicating that an electronic coupon can be downloaded by those watching. User 100 pings OI-Id Provider 210A-4, which is embedded in TV 277, in order to receive the electronic coupon. The TV system transmits and stores OI-Id 115 in a manner similar to the radio system in the third scenario.

The RF technology used to implement the various scenarios in FIG. 2A could be implemented by any low-power short-distance RF system or protocol, as exemplified by Bluetooth, HiperLAN, and the IEEE 802.16 standard. In addition, OI-Id Providers 210A may be passive circuitry designed to be powered by an external low-power RF signal, or may be active circuitry which responds to pings broadcast using a low-power RF standard.

In the three scenarios of FIG. 2B, PSA 120 is implemented as cellular telephone 220B and OI-Id Providers 210B provide OI-Id to cellular telephone 220B without a prompt from either user 100 or cellular telephone 220B. In this implementation, the native capabilities of cellular telephone 220B are used for communication means. In other words, the RF transceiver in cellular telephone 220B normally used for telephone communication is also used to transmit OI-Id 115. There are a wide variety of ways in which this could be implemented. For example, the cellular telephone's Short Message Service (SMS) capability, typically used for paging and messaging functions, could be used to transmit a text version of OI-Id 115. As another example, the cellular telephone communication protocol, such as GSM (Global System for Mobile Communication) or IMT-2000 (International Mobile Telecommunications-2000), could be adapted so that one multiplexed channel is used as a broadcast medium for transmitting OI-Id 115 to one or more cellular telephones. In other embodiments, a low-power short-range RF functionality may be added to the cellular telephone (e.g., by adding a Bluetooth chip) in order to communicate with OI-Id Providers 110. The exemplary implementation of FIG. 2B is not limited to any particular manner of performing OI-Id 115 broadcast transmission using cellular telephone 220B and/or the cellular telephone system.

In the first scenario of FIG. 2B, user 100 is at concert event 280, where Band X is playing. OI-Id Provider 210B is implemented as RF beacon 210B-1 which transmits broadcast signal capable of being received by cellular telephone 220B. During concert event 280, RF beacon 210B-1 transmits, at least once, a broadcast OI-Id 115 message which is received by all cellular telephones on that cellular network in the audience, including cellular telephone 220B. Cellular telephone 220B then presents the OI-Id to user 100 in the appropriate format. The appropriate format may be a typed message appearing on cellular telephone 220B's built-in display screen or a voice, or simulated voice, message arriving as a telephone call. For instance, the display screen might display the message “Get Band X's new hit delivered to your PC when you get home—just send paging message <Band X #1> to 800-123-4567 now”. Or cellular telephone 220B might ring, and when user 100 answers, a recorded message from the lead singer of Band X might say “Hi, this is Joe Singer! Just because you came to see us tonight, you can get our new CD for half price by pressing the <send> button now”. What will happen if user 100 performs the requested action will depend on which embodiment of the present invention is being used and how the other components, such as ISS 130, are being implemented.

In the second scenario of FIG. 2B, user 100 is in music store 283 which has RF beacon 220B-2 placed somewhere on the premises. By this means, an OI-Id concerning CDs or CD-related products may be transmitted to cellular telephone 220B In addition, it may have been previously determined by marketing research that music store 283 is frequented by teens and young adults between the ages of 16 and 24. A company whose target consumers are in that age group would use RF beacon 220B-2 to send OI-Id 115 to potential customers. For example, RF beacon 220B-2 may intermittently transmit a display or voice message from McDonald's stating “You deserve a break today—Get a Big Mac for half price by calling 800-123-4567”.

In the third scenario, at 285 in FIG. 2B, another example of consumer targeting is shown. This example is based on a commonly owned U.S. patent application Ser. No. 09/764709 filed Jan. 18, 2001, entitled REAL-TIME WIRELESS E-COUPON (PROMOTION) DEFINITION BASED ON AVAILABLE SEGMENT (hereinafter referred to as “E-COUPON”), which is hereby incorporated by reference. In E-COUPON, consumer telephones are targeted for receipt of advertising messages or electronic coupons based on certain criteria. In one embodiment, users are targeted based on their individual user profiles. For example, a user profile may show a user's preference for music by Band X, so advertising and/or electronic coupons related to Band X will be targeted to that user. At 285 in FIG. 2B, user 100 has a targeted OI-Id 115 being sent to him from cellular telephone Base Station 220B-3. The cellular telephones of other cellular telephone users 288 in the same system have not been targeted and do not receive the OI-Id. In this case, user 100 may be anywhere within the cellular telephone system when he receives OI-Id 115.

FIG. 2C shows some exemplary non-RF implementations of transferring OI-Id 115 between OI-Id Providers 210C and PSAs 220C. In addition, FIG. 2C shows some other examples of PSA mobile terminals, besides the PDA 220A of FIG. 2A and the cellular telephone 220B of FIG. 2B. PSA 220C-1 is a watch-like mobile terminal which is worn on user 100's wrist. Watch-like mobile terminal 220C-1 has some form of input means, such as a keypad or a touchscreen, whereby user 100 may enter data. As voice recognition technology improves, it is contemplated that the input means of watch-like mobile terminal 220C-1 may be an embedded mini-microphone into which user 100 speaks.

While in furniture store 290, user 100 spots an armoire 291 which he is considering purchasing. Armoire 291 has a label 210C-1 on which an identification code, consisting of numbers and/or letters, is printed. In this instance, the printed identification code is the OI-Id, and user 100 inputs this identification code into watch-like mobile terminal 220C-1. This OI-Id may enable many types of functionality. For example, user 100's input of the identification code may result in a facts and figures brochure concerning armoire 291 being downloaded to a PC at user 100's home. As another example, such input may result in a rebate offer being downloaded to user 100's home PC, where the downloaded rebate may be implemented electronically upon proof of purchase. As yet a further example, such input may result in an offer, such as “If this item goes on sale, would you like to be informed?”, being displayed in the display of watch-like mobile terminal 220C-1. If user 100 responds affirmatively, a message containing pertinent information is sent to ISS 130 which appropriately disposes the information for future use.

Departing momentarily from the description of the functional module implementations in FIG. 2C, it should be noted that a system implementation particularly suited to a user-entered identification code scheme as described in the last paragraph is a local phone company information management service. In a local phone company information management service, a local phone company, such as a cellular telephone company, would offer identification code services to local companies for a fee. Once the fee is paid, the local company would be able to apply labels with predetermined identification codes to advertisements, retail goods, etc. The local phone company would keep a database matching each predetermined identification code with a particular product, service, or promotional offer of a particular merchant. When an identification code is received from a mobile terminal, the phone company matches the appropriate user information with the product/service/offer information and then acts accordingly. The identification code labels could be conspicuously marked so that users recognize that the labels are part of the local phone company's information management system. For instance, every identification code could be printed with an easily recognizable insignia or symbol and the words “MobileNet Infocode”.

Returning to FIG. 2C, another implementation of PSA 120 is shown as portable laptop computer 220C-2 which user 100 is using while sitting in Internet Café 292. Portable laptop computer 220C-2 is equipped with an infrared (IR) transceiver. A possible IR technology to use is IrDA (Infrared Data Association) standard technology. Internet Café 292 is equipped with IR transceiver 210C-2 which operates as an OI-Id Provider 110. User 100 may ping IR transceiver 210C-2 with the IR transceiver in his laptop, or IR transceiver may intermittently send out OI-Id 115. IR transceiver 210C-2 is embedded in a wall display concerning upcoming entertainment events to be held at Internet Café 292. The OI-Id 115 transmitted from IR transceiver 210C-2 to laptop 220C-2 may enable many forms of functionality. For instance, it may enable an e-mail containing the schedule of upcoming events to be sent to user 100's e-mail mailbox, or it may enable an electronic coupon to be sent to user 100's home PC, etc.

Yet another implementation of PSA 120 is dedicated device, or “wand”, 220C-3, which user 100 is carrying while browsing in bookstore 294. The only purpose of Wand 220C-3 is to retrieve OI-Id 115 from OI-Provider 210-C, and then transmit at least the OI-Id 115 to ISS 130. In an embodiment using the functional modules of FIG. 1B, Wand 220C-3 may store OI-Id 115 for later download to a home personal computer (acting as I/O module 150) of user 100. Wand 220C-3 uses a laser-scanner to scan in OI-Id 115 from OI-Id Provider labels 210C-3. In one embodiment, these labels are Uniform Product Code (UPC) or European Article Numbering (EAN) barcode labels. In another embodiment, Wand 220C-3 has a microphone capable of detecting ultrasonic sound. In such an embodiment, the OI-Id Providers 110 produce ultrasonic signals carrying OI-Id 115.

Although FIGS. 2A, 2B, and 2C refer to particular technologies embodied in particular implementations, it should be understood that the technologies are not limited in any way to their particular implementations. For instance, a cellular telephone 220B could have been used in FIG. 2A, and a PDA 220A could have been used in FIG. 2B. Voice recognition technology was discussed in reference to watch-like mobile terminal 220C-1, but voice recognition could be used in PDA 220A or cellular telephone 220B. Barcode scanning was discussed with reference to Wand 220C-3, but PDA 220A or cellular telephone 220B could have just as easily been outfitted with a laser-scanner. Furthermore, different technologies could be used simultaneously. For example, a PSA 120 may be able to receive low-power RF signals from OI-Id Providers 110, but may also be equipped so that user 100 may enter OI-Id 115 manually.

In addition, it should be noted that the choice of technology for implementing PSA 120, OI-Id Provider 110, and the communication link between them has no effect on the choice of technology for the other communication links in the system. For instance, in an implementation in which Wand 220C-3 uses ultrasonic signals to receive OI-Id 115, Wand 220C-3 might use a local cellular network to transmit signals to ISS 130. Lastly, at points in the above discussion, examples of system-wide implementations were discussed in order to clarify functionality; however, the instances where system-wide functionality was discussed in no way limits a particular implementation to a particular system-wide functionality. For example, although a system-wide implementation of a local phone company information management service was discussed with reference to the printed OI-Id label of FIG. 2C, such a printed OI-Id label implementation may be used with any system implementation.

FIGS. 3A, 3B, and 3C show various implementations of ISS 130, Output 140 or I/O 150, and the communication links between ISS 130 and PSA 120 and between ISS 130 and Output 140 or I/O 150.

In FIG. 3A, PSA 120 is implemented in a cellular telephone 320. Cellular telephone has a communication link with base station (BS) 321, which is part of cellular network 322. In this implementation, the cellular telephone 320 uses the Short Message Service (SMS) capability to transmit OI-Id 115. In this FIG. and the ones following, the circled numbers represent steps that correspond to the steps listed in the text. The PSTN (Public Switch Telephone Network) 330 to which cellular network 322 is connected maintains an OI-Id Server/Database 332, where each OI-Id has a matching product and/or service (P/S) IP address, and a UID-Info Server/Database 334, where user information is stored indexed by UID. After cellular telephone 320 transmits an SMS message carrying OI-Id 115 at step 1, the SMS message is sent to the Short Message Service Center (SMSC) 323 in step 2, where it is processed and delivered to PSTN 330. Inside PSTN 330, the OI-Id is matched up with the corresponding P/S IP address in OI-Id Server/Database 332 at step 3. Once matched, PSTN 330 sends, at step 4, a query over the Internet 340 to the P/S-Info Server 350 asking for more information concerning the original OI 101 from which user 100 downloaded the OI-Id. P/S-Info Server 335 is maintained by the manufacturer/provider of the originating OI 101. In step 5, P/S-Info Server 350 sends back the requested information (P/S-Info). OI-Id Database/Server 332 may also cache P/S-Info 135 in order to decrease communication latency.

Simultaneously with steps 3, 4, and 5, PSTN 330 is using the user's identification (UID) in step 6 to find the user information file (UID-Info) in the UID-Info Server/Database 334. Although the UID is depicted as coming from UID storage 336 in FIG. 3A, the UID may come from any source within or without PSTN 330. For example, UID may have come with the original OI-Id from SMSC 323. Once matched, PSTN 330 uses the matched UID-Info in step 7 to discover the IP address (PC IP) of user 100's PC 370 at user 100's home 360. Finally, PSTN 330 sends in step 8 the P/S-Info to user 100's home PC 370 (or another remote location), using PC IP. In this implementation, as well as all the others, it is possible that any message sent to user 100 is actually sent to a mail server, where it is stored until user 100 connects with the Internet 340 and downloads it.

The user information file UID-Info may be used for various types of consumer tracking. One example is described in the commonly owned European Patent Application No. 1 059 599 filed Jun. 6, 2000, entitled METHOD AND APPARATUS FOR RETRIEVING SPECIFIC INFORMATION ASSOCIATED WITH AN OBSERVED INDENTIFIER [sic] (hereinafter referred to as “RETRIEVING INFO”), based upon U.S. patent application Ser. No. 328138 filed Jun. 8, 1999, both of which are hereby incorporated by reference. In RETRIEVING INFO, a system is disclosed where a user uses a mobile telephone to enter and transmit an object identifier to a service provider. The service provider responds by sending data related to the object back to the mobile telephone. In addition, the service provider may maintain a personal database for each user, in which user information, such as likes and dislikes, past purchases, and ratings of objects (such as rented movies) entered by the user, is stored and can be accessed.

Many of the details required in a cellular telephone network and the SMS system, such as the Visitor Location Register (VLR), Home Location Register (HLR), the Short Message Service Gateway (SMSG), etc., were omitted from FIGS. 3A, 3B and 3C and their descriptions for purposes of focussing on the implementations. One skilled in the art knows the various components comprising a SMS system, a cellular telephone system, and a PSTN. In fact, the various components shown added to PSTN 330 in FIG. 3A could be moved to cellular system 322 for purposes of efficiency. Furthermore, the term “database/server” is used for convenience in order to consolidate different, but related, functions. Terms such as “server” and “database” should be understood in their most generic functional sense. The term “server” should be understood within the client/server architectural model-the client requests a service, the server provides a service. The term “database” can be understood in its most broad definition, as a data structure storing records. Thus, the database/servers described are functional simplifications. Any of the database/servers could be implemented using a distributed network system, where the functional elements of a server or a database are not only distributed among nodes, but will often migrate from node to node. On the opposite end of the spectrum, all of the servers and databases discussed could be resident on one mainframe computer. However much of each server or database is implemented in software, firmware, or hardware is also open to many variations, as is well known in the art.

In FIG. 3B, a more direct line of communication is made between user 100 and P/S-Info Server 350B. In this implementation, user 100 transmits OI-Id 115 in an SMS message from cellular telephone 320 at step 1. In this implementation, OI-Id 115 comprises at least an Internet IP address (P/S IP) from which P/S-Info may be obtained. This could take the form of an Uniform Resource Locator (URL) address (such as nokia.com) or an explicit IP address, (such as 123.45.67.8). At step 2, the SMSC receives the SMS message containing the P/S IP and, after processing, forwards it to Short Message Service Gateway (SMS-G) 325. SMS-G 325 is a direct gateway between the SMS system and the Internet 340. In other implementations, the message might transit several systems before reaching the Internet 340. For example, the SMS system might forward messages to a PSTN, which may forward recognized IP messages to an Internet gateway. In step 3 of this implementation, SMS-G not only properly formats the message so it is compatible with the Internet 340, but also attaches a user identification in the form of a IP address (U-IP). This type of conversion and control process for bringing SMS messages to the Internet is described in the commonly owned PCT Application No. PCT/FI97/00547 filed Sep. 15, 1997, entitled DATA SERVICE IN A MOBILE COMMUNICATION NETWORK (hereinafter referred to as “DATA SERVICE”), based upon Finnish Patent Application 963659 filed Sep. 16, 1996, both of which are hereby incorporated by reference. In DATA SERVICE, a system is disclosed whereby an SMS message containing an IP address may be transmitted from a cellular telephone, be received by the SMSC, and be forwarded directly onto the Internet to the IP address. By these means, a TCP or other IP connection may be initiated and maintained between the cellular telephone and the server at the IP address. In the implementation of FIG. 3B, it is not necessary to set up a connection, as will be seen from the description.

In FIG. 3B, the IP message 341, which has the address of the P/S-Info server 350B (P/S IP) as well as the user's home IP address (U-IP), is sent from SMS-G 325 over the Internet 340 to P/S-Info Server 350B at step 4. At step 5, P/S-Info Server 350B receives IP message 341, finds the appropriate P/S-Info, and sends the appropriate P/S-Info in an IP message 342 to the IP address indicated by U-IP. The U-IP address is the IP address of user 100's PC 370 at his home 360. In cases where the P/S-Info Server 350B has many products and/or services in the system, the original SMS message from cellular telephone 320 may contain both P/S IP and OI-Id. In those cases, the OI-Id is also received at P/S-Info Server 350B so that the P/S-Info Server 350B may find the appropriate P/S-Info.

Although the FIG. 3B implementation is simpler than the FIG. 3A implementation, it is much less secure in terms of privacy protection. In FIG. 3A, the PSTN 330 asks for, and receives, the P/S-Info from the P/S-Info Server 350A. Thus, user 100's identity is hidden from P/S-Info Server 350A, preventing unwanted e-mails received from, and user-specific database files maintained by, the manufacturer of OI 101. On the other hand, the implementation of FIG. 3B gives the owner of P/S-Info Server 350B the user's home PC address (U-IP), from which a database record could be maintained. This database record could be added to every time user 100 makes an inquiry regarding a product and/or service whose P/S-Info is maintained at P/S-Info Server 350B. The business models for the two figures also differ. In FIG. 3A, the phone company is providing this service to its customers, and may bill additional fees for it. In FIG. 3B, the phone company merely provides an SMS/Internet connectivity for which it may charge a flat fee, but not as an information providing service. P/S-Info Server 350B presumably would not charge fees because it wants users to obtain P/S-Info regarding its products and/or services.

The implementation in FIG. 3C is similar to the FIG. 3A implementation because it does not allow the manufacturers/providers direct access to the users; however, it is also similar to the FIG. 3B implementation because PSTN 330 is not involved in the service. Instead, a data clearinghouse 380, reachable through the Internet 340, maintains both the P/S-Info Server 350 and the UID-Info Database/Server 334C. Data clearinghouse 380 may be a marketing company, a general information provider, or other service agency which may take fees (either from user 100 or manufacturers/providers of products and/or services) for the service of providing P/S-Info to interested consumers. In this implementation, the UID-Info Database/Server 334C has UID-Info records with user addresses and preference information and the P/S-Info Server 350C has matching P/S-Info for every OI-Id. In this centralized architecture, data clearinghouse 380 maintains P/S-Info records on behalf of the manufacturers/providers, rather than redirecting queries to separate P/S-Info Servers maintained by various manufacturers/suppliers as is shown in FIG. 3A. In addition, data clearinghouse 380 saves preference data for each individual user to be used for targeted advertisements/promotions and marketing research.

At step 1 in FIG. 3C, user 100 sends an OI-Id over an RF connection to base station 321. Unlike the previous figures, the protocol used for this transmission is not specified. This is to reinforce the fact that any sort of RF protocol which is compatible with cellular network 322 may be used. At step 2, the transmitted OI-Id is sent to and processed by cellular network 322, before being forwarded to PSTN 330, which forwards the OI-Id over the Internet 340 in step 3. How cellular network 322 processes the message depends upon the protocol used. Likewise, the manner in which PSTN 330 receives the OI-Id and processes it for transport over the Internet 340 may be adapted to the needs of the system. A user identification (UID) that identifies user 100 is appended to the OI-Id by either cellular network 322 or PSTN 330. Thus, the resulting outgoing IP message 343 contains at least OI-Id and UID. In this implementation, all IP messages containing OI-Ids from user 100 are forwarded to the same IP address, namely, the IP address of data clearinghouse 380. Because of this, PSTN 330, cellular network 322, or cellular telephone 320 must be preset in such a manner that IP message 343 is correctly addressed to data clearinghouse 380 and that a UID recognizable by data clearinghouse 380 is appended to it.

Once IP message 343 is received by data clearinghouse 380, the OI-Id and UID it carried are separated at step 4. At step 5, the UID is sent to UID-Info Database/Server 334C, where the matching user information file (UID-Info) is found. The OI-Id is sent, at step 6, to P/S-Info Server 350C, where the matching P/S-Info file is found. The P/S-Info files in P/S-Info Server 350C are maintained by data clearinghouse 380, but they are supplied by the individual manufacturers/providers of the individual products and/or services to which the P/S-Info refers. In another implementation, data clearinghouse 380 would regularly check with each manufacturer/provider to see if the P/S-Info has changed at all.

Once both the P/S-Info file and UID-Info file have been found, data clearinghouse 380 at step 7 accesses the U-IP in the found UID-Info in order to address IP message 345 to user 100's home PC 370. Next, in step 8, data clearinghouse 380 properly formats P/S-Info to fit into IP message 345 and, at step 9, transmits the formatted message over the Internet 340 to user's home PC 370. It is also possible that data clearinghouse 380 would maintain “mailboxes” for individual users, where each user would access their mailbox by logging into a server at data clearinghouse 380 over the Internet 340.

Similarly to FIGS. 2A, 2B, and 2C, although FIGS. 3A. 3B, and 3C refer to particular technologies embodied in particular implementations, it should be understood that the technologies are not limited in any way to their particular examples. For instance, although the SMS system in FIG. 3B has direct access to the Internet 340, such a direct connection could also be maintained in FIG. 3A, if the various components shown inside PSTN 330 are moved somewhere within, or connected to, the SMS system. As another example, in a manner similar to FIG. 3C's data clearinghouse 380, PSTN 330A in FIG. 3A may have P/S-Info Server 350 integrated inside it, thus maintaining P/S-Info files in the same manner as data clearinghouse 380.

Although the OI-Key embodiment shown in FIG. 1B has not been explicitly discussed with reference to FIGS. 3A, 3B, and 3C, most of the concepts behind FIG. 1B would be implemented in a similar manner. For instance, in FIG. 3A, OI-Key Server 139 would be maintained by PSTN 330A and user 100 would sent the OI-Key 129 directly from home PC 370 to P/S-Info Server 350 in order to receive P/S-Info or OI. As another example, in FIG. 3B, P/S-Info Server 350B may operate as both P/S-Info Server 350 and OI-Key Server 139. In such an implementation, user 100 would send a short SMS message to P/S-Info Server 350B and receive back an OI-Key 129 in the form of a short SMS message (such as “Go to www.nokia.com/main/offer345; your password is “goliath”). Once user 100 has returned home, he would access P/S-Info Server 350B again, using the received URL, and enter the received password in order to get a rebate, electronic coupon, OI, or the like. A FIG. 3C implementation could work in a comparable manner.

Having explored various implementations of the functional modules shown in FIGS. 1A and 1B, now two specific system-wide embodiments will be described. These embodiments are merely exemplary, created in order to show how an entire system according to the present invention might work. Although all of the technology in these embodiments exists, some of the specific technologies have not yet been implemented in any telephone system.

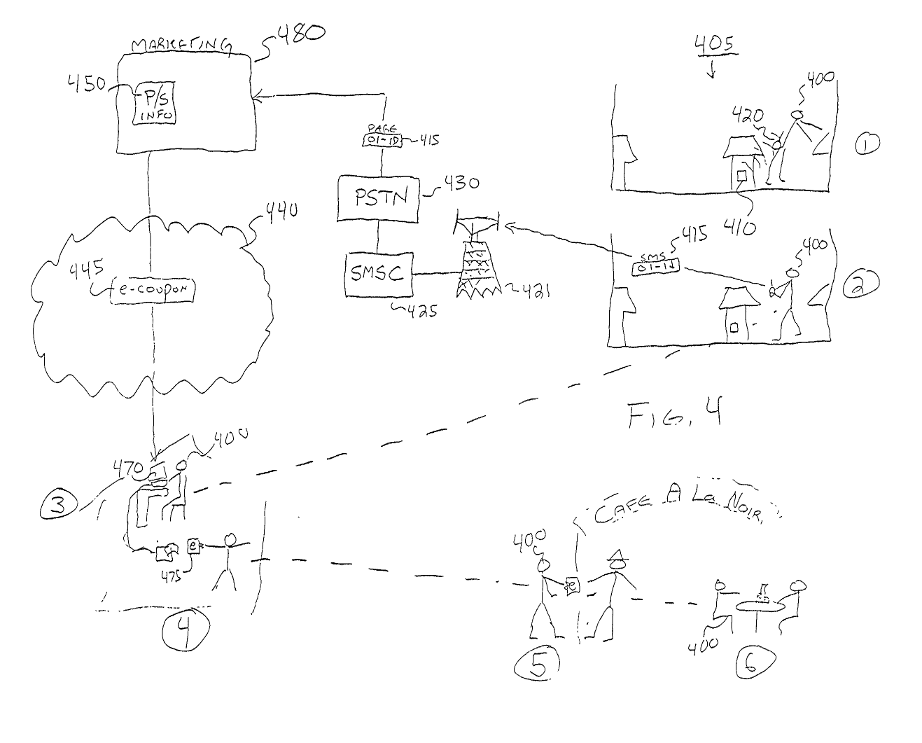

FIG. 4 is one specific embodiment of a FIG. 1A system according to the present invention. Consumer 400 has a cellular telephone 420, which is equipped with a Bluetooth chip. The steps in parentheses only represent those taken by consumer 400. While consumer 400 is browsing in classical music store 405, her cellular telephone 420 receives an incoming Bluetooth transmission at step 1 from a Bluetooth transmitter 410 which is built into one of the display stands in music store 405. The transmission causes the display on cellular telephone to show the message “Cafe A La Noir invites you to a candlelight dinner for two, with complimentary dessert and bottle of champagne. R.S.V.P. by pressing YES or NO.” A marketing company 480 has previously discovered that the clientele at classical music store 405 overlaps with the clientele of Cafe A La Noir and has arranged for the placement of Bluetooth transmitter 410 as well as the offer from Cafe A La Noir. Marketing company 480 is analogous to a billboard agency that rents space for a billboard and then sells the display space on the billboard. In other embodiments, it is possible that PSTN 430 acts in this capacity or that Cafe A La Noir and classical music store 405 make these arrangements directly.

At step 2, consumer 400 responds to the Bluetooth message by pressing “YES” on cellular telephone 420. Obviously, in this embodiment, cellular telephone 420 has been enabled with full Bluetooth interoperability; however, in other embodiments, the message might just indicate a telephone number or a URL to contact. Using its SMS capability, cellular telephone 420 transmits to base station 421 an SMS message 415 which contains the telephone number of marketing company 480 and an OI-Id which identifies both marketing company 480 and this particular offer. SMS message 415 is processed by SMSC 425 and PSTN 430, which sends the SMS message 415 as a page to the telephone number of marketing company 480. PSTN 430 and marketing company 480 have a previous arrangement in which PSTN 430 provides a consumer identification in SMS messages to marketing company 480. Once SMS message 415 is received at marketing company 480, marketing company 480 matches the OI-Id to the correct P/S-Info record in its P/S-Info Server 450. The matching P/S-Info record is an e-coupon 445 with a code or certificate of authenticity to prove that it is genuine. The marketing company 480 uses the consumer identification to determine the IP address of consumer 400's home PC 470. Then marketing company forwards e-coupon 445 over the Internet 440 to consumer 400's home PC 470. Later on, when consumer 400 returns home, she, in step 3, downloads e-coupon 445 and prints it out in step 4. Several nights later, consumer 400 proffers printed e-coupon 475 at step 5 and then, in step 6, has dinner for two with complementary dessert and champagne at Cafe A La Noir 490.

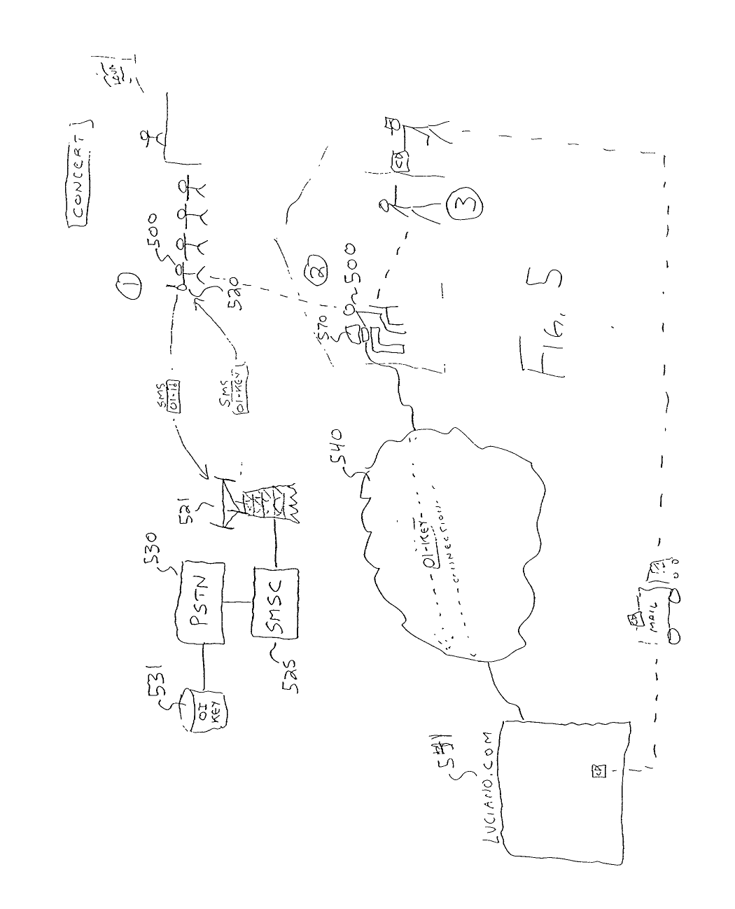

FIG. 5 is one specific embodiment of a FIG. 1B system according to the present invention. Consumer 500 has a cellular telephone 520 and is attending a Luciano Pavarotti concert. Here again, the steps in parentheses only represent those taken by consumer 500. During the performance, the following message is displayed to the audience: “Get Luciano's Greatest Hits CD at half price! Just send “I Love Luciano” to 1-800-123-4567 now.” At step 1, consumer 500 sends a page with the message “I Love Luciano” (OI-Id) using the SMS capability of cellular telephone 520. PSTN 530 receives this page from the SMSC 525 and retrieves the appropriate response message from OI-Key server 531. In this embodiment, PSTN 530 is providing the OI-Key service rather than a separate entity. PSTN 530 earns additional fees by providing such automated services, which are cheap and easily performed by PSTN 530. In this case, the response message (OI-Key) is an SMS message that reads: “Go to www.luciano.com/concertCD; use password: FGY56D23”. Later on, when consumer 500 returns home, consumer 500 turns on her PC 570, connects to the Internet 540, and, in step 3, goes to webpage www.luciano.com/concertCD (maintained at webserver LUCIANO.COM 541) where she enters the password “FGY56D23” (OI-Key) at the appropriate prompt. At this point, a secure web page appears where consumer 500 enters billing and shipping information. With this information, LUCIANO.COM mails out CD 501 to consumer 500, which she receives in step 3. If cellular telephone 520 was equipped with a Bluetooth chip, as cellular telephone 420 was, it would be possible for the URL address and the password to be directly downloaded to PC 573, thus obviating the need for consumer 500 to manually enter them.

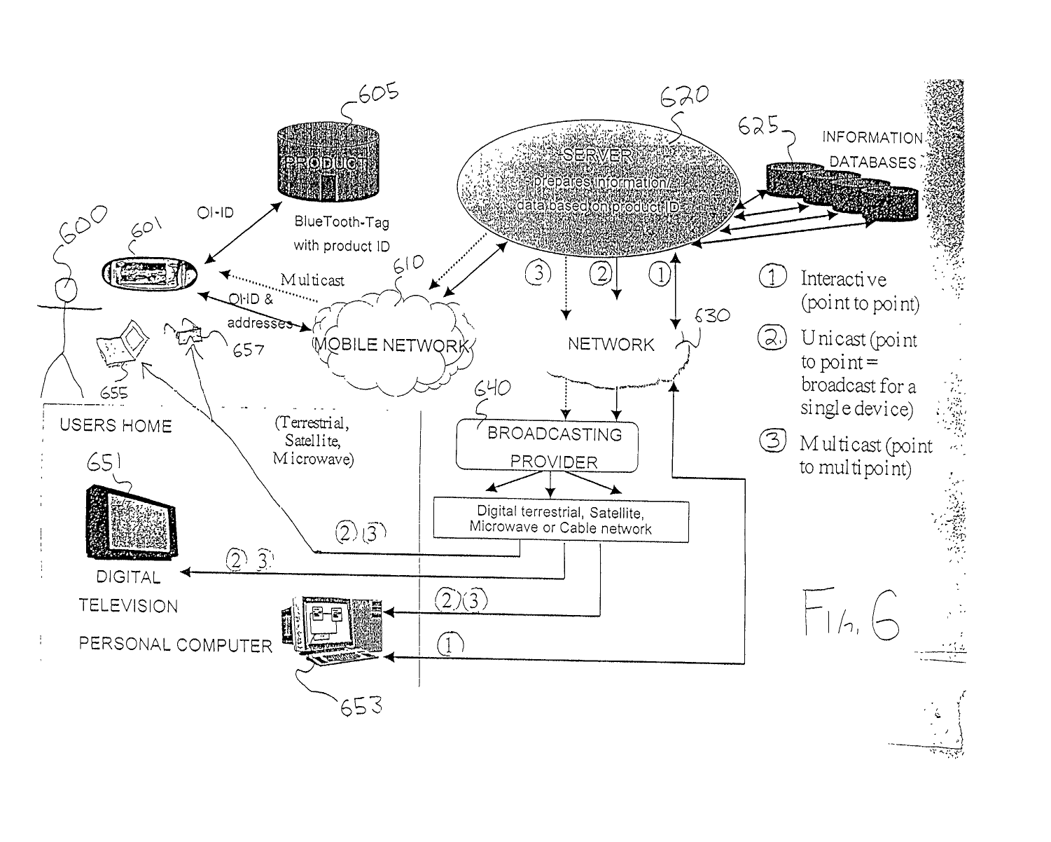

FIG. 6 is another specific embodiment of a FIG. 1A system according to the present invention. User 600 has a mobile terminal 601 (acting as a PSA) which is a subscriber to mobile telephone network 610. User 601 encounters an OI 605 that has a Bluetooth tag as an OI-Id provider, which provides an OI-Id to terminal 601. Terminal 601 adds to the OI-Id the communication destination address of where the user wants the P/S-Info concerning the OI to be output and sends it, via an SMS message to mobile network 610, which forwards it to server 620. Server 620 determines the location in Information Databases 625 of the P/S-Info that corresponds to OI 605 by means of the OI-Id in the message sent from terminal 601. Having retrieved the corresponding P/S-Info, server 620 forwards the P/S-Info to the appropriate output means, as indicated by the communication destination address which terminal 601 added to the OI-Id before sending it to server 620.

In the embodiment of FIG. 6, there are multiple choices for a communication path to user 601's preferred output device, as well as multiple output devices. Network 630, which could, for example, be the Internet, connects server 620 with a variety of broadcast providers 640, each of which provides a different path to one or more output devices. One broadcast provider is a type of digital terrestrial broadcast system, such as Digital Audio Broadcast (DAB) and Digital Video Broadcast (DVB). The other broadcast providers include a satellite broadcast system, a microwave antenna broadcast system, and a cable television (CATV) broadcast system. Which broadcast provider 640 is chosen depends on the communication destination address sent by terminal 601. As indicated by the circled numerals, the mode of transmission may also vary, from (1) Interactive (point-to-point) or (2) Unicast (point-to-point: broadcast to a single device) to (3) Multicast (point-to-multipoint). In FIG. 6, an interactive, point-to-point connection is maintained between personal computer (PC) 653 and server 620 through network 630. A multicast, or unicast, mode connection could be maintained through one of the broadcasting providers 640.

Furthermore, the output devices vary. One or more of the broadcast systems may have a communication link with digital television 651 or personal computer (PC) 653. Network 630 (e.g., the Internet) may have a direct connection with one or more of the output devices, such as PC 653. The output device might be carried by user 600. For example, the output device could be a laptop computer 655 or a pair of virtual reality goggles 657.

In an embodiment using different broadcast communication modes (e.g., unicast or multicast), it would be possible to more efficiently transmit P/S-Info to the output devices of various users. For example, a server at the ISS could track the number of requests for identical P/S-Info from different users whose output devices are in the same broadcast cell. Once the number reaches a certain threshold, the P/S-Info is broadcast to the output devices. For convenience, if the output device is being carried by the user, the P/S-Info may be broadcast immediately.

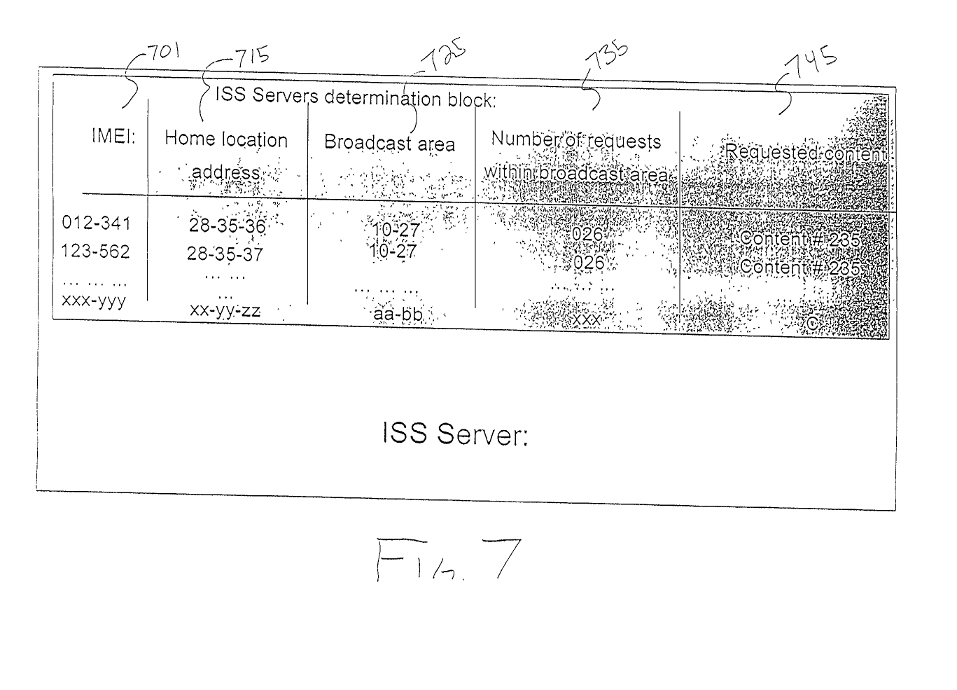

FIG. 7 shows an ISS server that would be used in such an embodiment to track requests and broadcast areas. As shown at 701, the IMEI (International Mobile Equipment Identity) of different PSAs (e.g., a cellular telephones) which requested P/S-Info. The IMEIs are used by the network to uniquely identify mobile communication stations; thus, each IMEI can also be associated with an individual user. Home location address 715 is the communication destination address of the output device for the user corresponding to the IMEI. Broadcast area 725 is the broadcast area, or cell, of the home location. Number of requests 735 indicate the total number of requests for particular P/S-Info in a particular broadcast cell. Requested content 745 is the identification number of the P/S-Info being requested by the PSA. In this case, there are 26 requests within broadcast cell 10-27 for P/S-Info #235. If this number exceeds a threshold value, the P/S-Info will be broadcast within that broadcast cell. However, if the output device indicated in Home location address 715 is something which is being carried by the user, such as a laptop or a PDA, the P/S-Info would be transmitted immediately.

As stated before, the specific embodiments in FIGS. 4 through 7 are exemplary, and many variations are possible, as is shown by FIGS. 2A through 3C. Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for providing information concerning a consumer item to a user comprising:
an object of interest (OI) identification information (OI-Id) provider, wherein the OI is a consumer item and said OI-Id provider is in a specific location;
a portable shopping assistant (PSA) for receiving the OI-Id in the specific location and for transmitting the received OI-Id;
an information server system (ISS) for receiving the OI-Id transmitted by said PSA, for matching the received OI-Id with a record containing consumer item information (P/S-Info) corresponding to the received OI-Id, for determining a communication method, and for transmitting the P/S-Info using the determined communication method; and
an output device for receiving P/S-Info from said ISS and outputting the P/S-Info to the user, said output device being separate from the PSA;
wherein the specific location is one of a location where the OI is present, a location having material associated with the OI, and a location where an event associated with the OI is taking place.

2. The system of claim 1, wherein, in the location where an event associated with the OI is taking place, the associated event comprises one of a concert, a lecture, and a sports event.

3. The system of claim 1, wherein the PSA comprises one of a cellular telephone, a personal digital assistant (PDA), a laptop computer, and a dedicated device.

4. The system of claim 1, wherein the PSA receives OI-Id by one of radiofrequency (RF) communication, infrared (IR) communication, sonic communication, label scanning and manual entry.

5. The system of claim 1, wherein the OI-Id comprises a consumer item identification code.

6. The system of claim 1, wherein the PSA receives the OI-Id by short-range, low power radiofrequency (RF) technology.

7. The system of claim 6, wherein the short-range, low power RF technology comprises one of Bluetooth technology, IEEE 802.16 technology, and HiperLAN technology.

8. The system of claim 1, wherein the PSA is a cellular telephone, further comprising:
a cellular telephone network for receiving the OI-Id transmitted by said cellular telephone and for transmitting the OI-Id to the ISS.

9. The system of claim 1, wherein the PSA is a cellular telephone, said cellular telephone being registered to receive services of the consumer item information system by having appropriate information entered in a file of a subscriber database maintained by a cellular telephone system.

10. The system of claim 1, wherein the PSA transmits the OI-Id by one of the Internet, a wired telephone network, a short-range, low power radio-frequency (RF) technology, a wireless local area network (WLAN), and a cellular telephone network.

11. The system of claim 10, wherein the short-range, low power RF technology comprises one of Bluetooth technology, IEEE 802.16 technology, and HiperLAN technology.

12. The system of claim 10, wherein the cellular telephone network comprises a third generation cellular telephone network.

13. The system of claim 1, wherein the ISS transmits the P/S-Info by one of the Internet, a wired telephone network, a broadcast network, a short-range, low power radio-frequency (RF) technology, a wireless local area network (WLAN), and a cellular telephone network.

14. The system of claim 13, wherein the broadcast network comprises one of a digital audio broadcast (DAB) system, a digital video broadcast (DVB) system, a satellite system, a microwave broadcast system, and a cable television system.

15. The system of claim 13, wherein the short-range, low power RF technology comprises one of Bluetooth technology, IEEE 802.16 technology, and HiperLAN technology.

16. The system of claim 13, wherein the cellular telephone network comprises a third generation cellular telephone network.

17. The system of claim 13, wherein the ISS determines which one of the Internet, a wired telephone network, a broadcast network, a short-range, low power radio-frequency (RF) technology, a wireless local area network (WLAN), and a cellular telephone network is used to transmit the P/S-Info.

18. The system of claim 1, wherein the PSA transmits OI-Id and the ISS transmits the P/S-Info using different communication networks.

19. The system of claim 1, wherein the output device is one of a personal computer at a home of the user, a television set at the home of the user, a portable laptop computer equipped with communication means, and a set of portable virtual reality goggles.

20. The system of claim 1, further comprising:
a means for attaching user information (UID-Info) to the OI-Id, said UID-Info comprising at least a communication destination address for the user;
wherein the ISS uses the communication destination address to address the P/S-Info to the output device.

21. The system of claim 20, wherein the UID-Info attaching means is one of the PSA and the ISS.

22. The system of claim 1, wherein the ISS comprises:
an OI-Id server for receiving the OI-Id, resolving a correct destination address for a P/S-Info server which has the record containing the P/S-Info corresponding to the received OI-Id, and transmitting a request for P/S-Info to a P/S-Info Server;
said P/S-Info server for receiving the request for P/S-Info, for finding the record containing the P/S-Info, and for transmitting the P/S-Info;
means for determining a user identification (UID) of a user of the PSA;
a user information (UID-Info) server containing UID-Info files sorted by user identification (UID) for matching a UID-Info file with said determined UID, wherein the UID-Info file comprises at least a communication destination address for the user; and
means for transmitting said P/S-Info to the communication destination address in the matching UID-Info file.

23. The system of claim 22, further comprising:
a public switched telephone network (PSTN) comprising the OI-Id server, the UID-Info server, and the means for determining a UID;
wherein the means for transmitting the P/S-Info comprises the Internet.

24. The system of claim 23, wherein the P/S-Info server is on the Internet and the P/S-Info request and response is transmitted over the Internet.

25. The system of claim 1, further comprising:
a cellular telephone comprising the PSA;
a short message service (SMS) system connected to a cellular telephone system and to the Internet, said cellular telephone being in a transmission area of said cellular telephone system, said SMS system for receiving the OI-Id, resolving a destination Internet Protocol (IP) address for a P/S-Info server which has the record containing the P/S-Info corresponding to the received OI-Id, resolving a destination IP address for the output device, and transmitting a request for P/S-Info containing the destination IP address of the output device over the Internet to the P/S-Info server; and
said P/S-Info server connected to the Internet for receiving said request for P/S-Info, for finding the record containing the P/S-Info, and for transmitting the P/S-Info to the output device.

26. The system of claim 1, further comprising:
a Bluetooth chip comprising the OI-Id provider;
a mobile terminal comprising the PSA;
a mobile network for receiving the OI-Id from the mobile terminal and for transmitting the OI-Id to the ISS;
the ISS comprising:
at least one information database for storing P/S-Info;
an ISS server for finding P/S-Info in the at least one information database based on the received OI-Id from the mobile terminal;
a network connected to the ISS server for transmitting the P/S-Info;
at least one broadcasting provider connected to the network for transmitting the P/S-Info, said at least one broadcasting provider comprising at least one of a digital audio broadcast (DAB) system, a digital video broadcast (DVB) system, a satellite system, a microwave broadcast system, and a cable television system; and
said output device comprising one of a personal computer at a home of the user, a television set at the home of the user, a portable laptop computer equipped with communication means carried by the user, and a set of portable virtual reality goggles worn by the user;
wherein the ISS server stores information indexed to each user, said indexed information being used by the ISS in determining the communication method and which one of the at least one broadcasting provider and the network is to be used to transmit the P/S-Info to the output device.

27. The system of claim 1, wherein the ISS further comprises:
a communication determination server for maintaining records concerning PSAs requesting P/S-Info and output devices corresponding to the requesting PSAs, and for broadcasting particular P/S-Info to output devices in a specific broadcasting area when a number of output devices in the specific broadcasting area corresponding to PSAs requesting particular P/S-Info exceeds a predetermined threshold value.

28. A system for providing information concerning a consumer item to a user comprising:
an object of interest (OI) identification information (OI-Id) provider, wherein the OI is a consumer item and OI-Id provider is in a specific location;
a portable shopping assistant (PSA) for receiving the OI-Id in the specific location, for transmitting the received OI-Id, and for receiving key information (OI-Key), the OI-Key comprising a means for accessing consumer item information (P/S-Info) concerning the OI;
an information server system (ISS) for receiving the OI-Id transmitted by the PSA, for matching the received OI-Id with a record containing an OI-Key corresponding to the received OI-Id, and for transmitting the OI-Key from the matching record to the PSA;
an input/output (I/O) device for receiving the OI-Key previously received by said PSA, for transmitting the received OI-Key to access consumer item information (P/S-Info) concerning the OI, and for accessing the P/S-Info; and
a P/S-Info server for receiving an OI-Key from said I/O device, for matching the received OI-Key with a record containing the P/S-Info, and for allowing said I/O device to access the P/S-Info;
wherein the specific location is one of a location where the OI is present, a location having material associated with the OI, and a location where an event associated with the OI is taking place.

29. The system of claim 28, wherein, in the location where an event associated with the OI is taking place, the associated event comprises one of a concert, a lecture, and a sports event.

30. The system of claim 28, wherein the PSA comprises one of a cellular telephone, a personal digital assistant (PDA), a laptop computer, and a dedicated device.

31. The system of claim 28, wherein the PSA receives OI-Id by one of radio-frequency (RF) communication, infrared (IR) communication, sonic communication, label scanning and manual entry.

32. The system of claim 28, wherein the OI-Id comprises a consumer item identification code.

33. The system of claim 28, wherein the PSA receives OI-Id by short-range, low power radio-frequency (RF) technology.

34. The system of claim 33, wherein the short-range, low power RF technology comprises one of Bluetooth technology, IEEE 802.16 technology, and HiperLAN technology.

35. The system of claim 28, wherein the PSA is a cellular telephone, further comprising:
a cellular telephone network for receiving the OI-Id transmitted by said cellular telephone and for transmitting the OI-Id to the ISS.

36. The system of claim 28, wherein the PSA is a cellular telephone, said cellular telephone being registered to receive services of the consumer item information system by having appropriate information entered in a file of a subscriber database maintained by a cellular telephone system.

37. The system of claim 28, wherein the output device is one of a personal computer at a home of the user, a television set at the home of the user, a portable laptop computer equipped with communication means, and a set of portable virtual reality goggles.

38. The system of claim 28, wherein the PSA transmits the OI-Id by one of the Internet, a wired telephone network, a broadcast network, a short-range, low power radio-frequency (RF) technology, a wireless local area network (WLAN), and a cellular telephone network.

39. The system of claim 38, wherein the broadcast network comprises one of a digital audio broadcast (DAB) system, a digital video broadcast (DVB) system, a satellite system, a microwave broadcast system, and a cable television system.

40. The system of claim 38, wherein the short-range, low power RF technology comprises one of Bluetooth technology, IEEE 802.16 technology, and HiperLAN technology.

41. The system of claim 38, wherein the cellular telephone network comprises a third generation cellular telephone network.

42. The system of claim 28, wherein the PSA communicates with the ISS and the P/S-Info Server communicates with the I/O device using different communication networks.

43. The system of claim 28, wherein the P/S-Info Server and the I/O device maintain a communication link by one of the Internet, a wired telephone network, a broadcast network, a short-range, low power radio-frequency (RF) technology, a wireless local area network (WLAN), and a cellular telephone network.

44. The system of claim 43, wherein the broadcast network comprises one of a digital audio broadcast (DAB) system, a digital video broadcast (DVB) system, a satellite system, a microwave broadcast system, and a cable television system.

45. The system of claim 43, wherein the short-range, low power RF technology comprises one of Bluetooth technology, IEEE 802.16 technology, and HiperLAN technology.

46. The system of claim 43, wherein the cellular telephone network comprises a third generation cellular telephone network.

47. The system of claim 43, wherein the one of the ISS and the P/S-Info Server determines which one of the Internet, a wired telephone network, a broadcast network, a short-range, low power radio-frequency (RF) technology, a wireless local area network (WLAN), and a cellular telephone network.

48. The system of claim 28, wherein the OI-Key comprises a communication destination address for the P/S-Info server.

49. The system of claim 48, wherein the communication destination address is an Internet Protocol (IP) address.

50. The system of claim 28, wherein the OI-Key comprises the OI-Id.

51. The system of claim 28, wherein the OI-Key is manually input to the I/O device by the user.

52. The system of claim 28, wherein the ISS comprises:
an OI-Key server having the record containing the OI-Key for receiving the OI-Id, for matching the record containing the OI-Key to the received OI-Id, and for transmitting the matched OI-Key to the PSA.

53. The system of claim 28, further comprising:
a cellular telephone network for transmitting the OI-Id to the ISS and transmitting the OI-Key to the PSA.

54. The system of claim 28, wherein the P/S-Info server is on the Internet, the OI-Key is transmitted to the P/S-Info server over the Internet, and the P/S-Info is transmitted to the I/O device over the Internet.

55. The system of claim 28, further comprising:
a cellular telephone comprising the PSA;
a short message service (SMS) system connected to a cellular telephone system and to the Internet, said cellular telephone being in a transmission area of said cellular telephone system, said SMS system for receiving the OI-Id, and for transmitting a request for an OI-Key corresponding to the received OI-Id; and
said OI-Key server having the record containing the OI-Key for receiving the request for the OI-Key, for matching the record containing the OI-Key to said received OI-Id, and for transmitting said OI-Key to the SMS system;
wherein the SMS system transmits the OI-Key to said cellular telephone.

56. A method for providing information concerning a consumer item to a user, comprising the steps of:
receiving, in a portable shopping assistant (PSA), an identifier (OI-Id) having identification information concerning an object of interest (OI), wherein the OI is a consumer item and said receiving occurs in a specific location;
transmitting the OI-Id by the PSA to an information server system (ISS);
matching by the ISS of the OI-Id with a record containing consumer item information (P/S-Info) concerning the OI;
determining which communication method to use to transmit the P/S-Info;
transmitting P/S-Info in the matching record to an output device, using the determined communication method, said output device being separate from the PSA; and
outputting of the P/S-Info by the output device to the user;
wherein the specific location is one of a location where the OI is present, a location having material associated with the OI, and a location where an event associated with the OI is taking place.

57. The method of claim 56, wherein, in the location where an event associated with the OI is taking place, the associated event comprises one of a concert, a lecture, and a sports event.

58. The method of claim 56, wherein the step of transmitting the OI-Id to said ISS comprises:
transmitting, by said PSA, a Short Message Service (SMS) message containing the OI-Id to a base station of a cellular telephone network;
receiving, by a Short Message Service Center (SMSC) of said cellular network, said SMS message containing the OI-Id; and
forwarding said processed message to the ISS.

59. The method of claim 56, wherein the step of matching by the ISS of the OI/Id with the record containing the P/S-Info concerning the OI comprises:
resolving a correct destination address for a P/S-Info server which has the record containing the P/S-Info;
transmitting a request for the P/S-Info to the P/S-Info Server; and
receiving the requested P/S-Info from the P/S-Info server.

60. The method of claim 56, wherein the PSA transmits the OI-Id by one of the Internet, a wired telephone network, a broadcast network, a short-range, low power radio-frequency (RF) technology, a wireless local area network (WLAN), and a cellular telephone network.

61. The method of claim 58, wherein the broadcast network comprises one of a digital audio broadcast (DAB) system, a digital video broadcast (DVB) system, a satellite system, a microwave broadcast system, and a cable television system.

62. The method of claim 58, wherein the short-range, low power RF technology comprises one of Bluetooth technology, IEEE 802.16 technology, and HiperLAN technology.

63. The method of claim 58, wherein the cellular telephone network comprises a third generation cellular telephone network.

64. The method of claim 56, wherein the P/S-Info is transmitted by one of the Internet, a wired telephone network, a broadcast network, a short-range, low power radio-frequency (RF) technology, a wireless local area network (WLAN), and a cellular telephone network.

65. The method of claim 64, wherein the broadcast network comprises one of a digital audio broadcast (DAB) system, a digital video broadcast (DVB) system, a satellite system, a microwave broadcast system, and a cable television system.

66. The method of claim 64, wherein the short-range, low power RF technology comprises one of Bluetooth technology, IEEE 802.16 technology, and HiperLAN technology.

67. The method of claim 64, wherein the cellular telephone network comprises a third generation cellular telephone network.

68. The method of claim 64, further comprising:
determining, by the ISS, which one of the Internet, a wired telephone network, a short-range, low power radio-frequency (RF) technology, a wireless local area network (WLAN), and a cellular telephone network is used to transmit the P/S-Info.

69. The method of claim 56, wherein the transmitting the OI-Id and the transmitting the P/S-Info are performed using different communication networks.

70. The method of claim 56, wherein the output device is one of a personal computer at a home of the user, a television set at the home of the user, a portable laptop computer equipped with communication means, and a set of portable virtual reality goggles.

71. The method of claim 56, further comprising the steps of:
attaching user information (UID-Info) to the OI-Id, said UID-Info comprising at least a communication destination address for the user;
wherein the communication destination address is used to address the P/S-Info to the output device in the transmitting P/S-Info step.

72. The method of claim 71, wherein the step of attaching UID-Info is performed by one of the PSA and the ISS.

73. The method of claim 56, wherein the step of transmitting the P/S-Info in the matching record to an output device comprises:
determining a user identification (UID) of the user;
matching a user information (UID-Info) record in a UID-Info server with said determined UID, where said UID-Info record comprises at least a communication destination address for the output device; and
transmitting the P/S-Info to the communication destination address in the matching UID-Info record.

74. The method of claim 56, further comprising:
maintaining records at the ISS with information indexed to each user, said indexed information being used by the ISS in determining the communication method.

75. The method of claim 56, further comprising:
maintaining records concerning PSAs currently requesting P/S-Info and output devices corresponding to the requesting PSAs; and
broadcasting particular P/S-Info to output devices in a specific broadcasting area when a number of output devices in the specific broadcasting area corresponding to PSAs requesting particular P/S-Info exceeds a predetermined threshold value.

76. A method for providing information concerning a consumer item to a user, comprising:
receiving, in a portable shopping assistant (PSA), an identifier (OI-Id) having identification information concerning an object of interest (OI), wherein the OI is a consumer item and said receiving occurs in a specific location;
transmitting the OI-Id by the PSA to an information server system (ISS);
matching by the ISS of the OI-Id with a record containing key information (OI-Key), the OI-Key comprising a means for accessing consumer item information (P/S-Info) concerning the OI;
transmitting by the ISS to the PSA of the OI-Key of the matching record;
inputting the OI-Key from the PSA to an input/output (I/O) device;
transmitting by the I/O device of the OI-Key to a P/S-Info server having a record containing the P/S-Info concerning the OI;
matching at the P/S-Info server of the OI-Key with a record containing the P/S-Info; and
allowing the I/O device to access the P/S-Info in the matching record;
wherein the specific location is one of a location where the OI is present, a location having material associated with the OI, and a location where an event associated with the OI is taking place.

77. The method of claim 76, wherein, in the location where an event associated with the OI is taking place, the associated event comprises one of a concert, a lecture, and a sports event.

78. The method of claim 76, wherein the step of transmitting the OI-Id by the PSA to the ISS comprises:
transmitting by the PSA a Short Message Service (SMS) message containing the OI-Id to a base station of a cellular telephone network; receiving and processing, by a Short Message Service Center (SMSC) of said cellular network, said SMS message containing the OI-Id; and
forwarding the processed message to the ISS.

79. The method of claim 76, wherein the PSA comprises a cellular telephone and the step of transmitting by the ISS to the PSA of the OI-Key comprises:
receiving, by a Short Message Service Center (SMSC) of a cellular telephone network, the OI-Key;
creating an SMS message containing the received OI-Key; and
transmitting the created SMS message containing the OI-Key from a base station of the cellular telephone network to the PSA.

80. The method of claim 76, wherein the step of inputting the OI-Key from the PSA to the I/O device comprises:
manually entering, by the user, the OI-Key.

81. The method of claim 76, wherein the step of inputting the OI-Key from the PSA to the I/O device comprises:
downloading the OI-Key from the PSA to the I/O device.

82. The method of claim 76, wherein the OI-Key comprises an Internet Protocol (IP) address of the P/S-Info server and the step of electronically transmitting by the I/O device of the OI-Key to the P/S-Info server comprises: transmitting an Internet Protocol (IP) message over the Internet to the IP address in the OI-Key.

83. The method of claim 82, wherein the OI-Key comprises a key code and the step of matching at the P/S-Info server of the OI-Key with the record containing the P/S-Info comprises:
starting a Transport Control Protocol (TCP) session between the I/O device and the P/S-Info server;
sending, in the TCP session, said key code in the OI-Key to the P/S-Info server; and
matching the key code with the record containing the P/S-Info.

84. The method of claim 76, wherein the output device is one of a personal computer at a home of the user, a television set at the home of the user, a portable laptop computer equipped with communication means, and a set of portable virtual reality goggles.

85. The method of claim 76, wherein the PSA transmits the OI-Id by one of the Internet, a wired telephone network, a broadcast network, a short-range, low power radio-frequency (RF) technology, a wireless local area network (WLAN), and a cellular telephone network.

86. The method of claim 85, wherein the broadcast network comprises one of a digital audio broadcast (DAB) system, a digital video broadcast (DVB) system, a satellite system, a microwave broadcast system, and a cable television system.

87. The method of claim 85, wherein the short-range, low power RF technology comprises one of Bluetooth technology, IEEE 802.16 technology, and HiperLAN technology.

88. The method of claim 85, wherein the cellular telephone network comprises a third generation cellular telephone network.

89. The method of claim 76, wherein the PSA communicates with the ISS and the P/S-Info Server communicates with the I/O device using different communication networks.

90. The method of claim 76, wherein the P/S-Info Server and the I/O device maintain a communication link by one of the Internet, a wired telephone network, a broadcast network, a short-range, low power radio-frequency (RF) technology, a wireless local area network (WLAN), and a cellular telephone network.

91. The method of claim 90, wherein the broadcast network comprises one of a digital audio broadcast (DAB) system, a digital video broadcast (DVB) system, a satellite system, a microwave broadcast system, and a cable television system.

92. The method of claim 90, wherein the short-range, low power RF technology comprises one of Bluetooth technology, IEEE 802.16 technology, and HiperLAN technology.

93. The method of claim 90, wherein the cellular telephone network comprises a third generation cellular telephone network.

94. The method of claim 90, further comprising:
determining, by one of the ISS and the P/S-Info Server, which one of the Internet, a wired telephone network, a short-range, low power radio-frequency (RF) technology, a wireless local area network (WLAN), and a cellular telephone network is used to transmit the P/S-Info.

95. A portable shopping assistant for providing information concerning a consumer item to a user, comprising:
a receiver unit for receiving an identifier (OI-Id) having identification information concerning an object of interest (OI), the OI-Id being received in a specific location;
at least one memory unit for storing processor-readable code and for storing selectable output device information comprising communication destination addresses of each of a plurality of output devices;
a processor operatively coupled to said at least one memory, said processor configured to implement said processor-readable code, said processor-readable code configured to:
maintain the selectable output device information;
allow the user to select selectable output device information comprising a communication destination address of a user desired output device; and
attach the user-selected selectable user information to the received OI-Id; and
a communication unit for communicating with a network for transmitting the OI-Id with the attached user-selected output device information to an information server system (ISS) via the network;
wherein the ISS, after receiving the OI-Id transmitted by said portable shopping assistant via the network, matches the received OI-Id with a record containing corresponding consumer item information (P/S-Info), determines a communication path to be used in transmitting the P/S-Info, and transmits the P/S-Info contained in the matching record to the user desired output device using the user-selected output device information attached to the OI-Id.

96. The portable shopping assistant of claim 95, wherein the portable shopping assistant is a cellular telephone, said cellular telephone being registered to receive services of the consumer item information system by having appropriate information entered in a file of a subscriber database maintained by a cellular telephone system.

97. The portable shopping assistant of claim 96, wherein the portable shopping assistant transmits the OI-Id by one of the Internet, a wired telephone network, a short-range, low power radio-frequency (RF) technology, a wireless local area network (WLAN), and a cellular telephone network.

98. The portable shopping assistant of claim 97, wherein the short-range, low power RF technology comprises one of Bluetooth technology, IEEE 802.16 technology, and HiperLAN technology.

99. The portable shopping assistant of claim 97, wherein the cellular telephone network comprises a third generation cellular telephone network.

100. The portable shopping assistant of claim 95, wherein the ISS server stores information indexed to each user, said indexed information being used by the ISS in determining the communication method.

101. The portable shopping assistant of claim 95, wherein the ISS maintains records concerning portable shopping assistants requesting P/S-Info and output devices corresponding to the requesting portable shopping assistants, and broadcasts particular P/S-Info to output devices in a specific broadcasting area when a number of output devices in the specific broadcasting area corresponding to portable shopping assistants requesting particular P/S-Info exceeds a predetermined threshold values.
